(19) United States
(12) Patent Application Publication
(10) Pub. No.: US 2020/0380727 A1
(43) Pub. Date: Dec. 3, 2020

(54) CONTROL METHOD AND DEVICE FOR MOBILE DEVICE, AND STORAGE DEVICE

(71) Applicant: SZ DJI TECHNOLOGY CO., LTD., Shenzhen (CN)

(72) Inventors: Yuanyuan TIAN, Shenzhen (CN); Chengwei ZHU, Shenzhen (CN); Ketan TANG, Shenzhen (CN)

(21) Appl. No.: 16/997,315

(22) Filed: Aug. 19, 2020

Related U.S. Application Data
(63) Continuation of application No. PCT/CN2018/077661, filed on Feb. 28, 2018.

(51) Int. Cl. G06T 7/80; G06T 7/73; B64C 39/02

(52) U.S. Cl. CPC G06T 7/80; G06T 7/74; B64C 2201/146; B64C 2201/127; B64C 39/024

(57) ABSTRACT

A method for controlling a mobile device includes obtaining a measurement image of a calibration device including a plurality of calibration objects, obtaining position-attitude information of the mobile device according to the measurement image, predicting a movement status of the mobile device according to the position-attitude information and a control instruction to be executed, and, in response to the predicted movement status not meeting a movement condition, constraining movement of the mobile device so that the movement status after constraining meets the movement condition.

### CROSS-REFERENCE TO RELATED APPLICATION

This application is a continuation of International Application No. PCT/CN2018/077661, filed Feb. 28, 2018, the entire content of which is incorporated herein by reference.

### TECHNICAL FIELD

The present disclosure relates to the control technology field, and more particularly, to a mobile device control method, a mobile device, and a storage device.

### BACKGROUND

As technology advances, more and more mobile devices are involved in lives and work of people. In particular, an unmanned aerial vehicle (UAV), as an unmanned aircraft operated by a remote controlling device and a self-provided program controlling device, is one of the most popular mobile devices in recent years.

A conventional mobile device relies on user control to achieve movement. In some embodiments, after receiving a control instruction, the mobile device directly executes the control instruction to perform a corresponding movement. In actual scenarios, a control instruction received by the mobile device may cause its movement to not meet a requirement. For example, if the user mistakenly sends a wrong instruction of moving left instead of a right instruction of moving right due to a maloperation, a problem may occur if the mobile device still directly executes the control instruction. Especially when the mobile device is moving in a limited space, directly executing an unsatisfactory control instruction may very likely damage the mobile device or a surrounding environment. How to achieve an accurate control of mobile devices is currently a very worthy research issue.

### SUMMARY

In accordance with the present disclosure, there is provided a method for controlling a mobile device including obtaining a measurement image of a calibration device including a plurality of calibration objects, obtaining position-attitude information of the mobile device according to the measurement image, predicting a movement status of the mobile device according to the position-attitude information and a control instruction to be executed, and, in response to the predicted movement status not meeting a movement condition, constraining movement of the mobile device so that the movement status after constraining meets the movement condition.

Also in accordance with the disclosure, there is provided a mobile device including a body, and a photographing device, a memory, and a processor provided at the body. The photographing device is configured to photograph a calibration device including a plurality of calibration objects to obtain a measurement image. The memory stores program instructions. The processor is configured to execute the program instructions to obtain the measurement image, obtain position-attitude information of the mobile device according to the measurement image, predict a movement status of the mobile device according to the position-attitude information and a control instruction to be executed, and, in response to the predicted movement status not meeting a movement condition, constrain movement of the mobile device so that the movement status after constraining meets the movement condition.

### BRIEF DESCRIPTION OF THE DRAWINGS

FIG. 1 is a schematic flowchart of a method for controlling a mobile device according to one embodiment of the present disclosure.

FIG. 2 is a schematic diagram showing a mobile device photographing a calibration device in an application scenario according to one embodiment of the present disclosure.

FIG. 3 is a schematic diagram showing setting a set range in a movement condition in an application scenario according to one embodiment of the present disclosure.

FIG. 4 is a schematic flowchart of a method for controlling a mobile device according to another embodiment of the present disclosure.

FIG. 5 is a schematic flowchart of a method for controlling a mobile device according to another embodiment of the present disclosure.

FIG. 6A is a schematic structural diagram of a calibration device according to one embodiment of the present disclosure.

FIG. 6B is a schematic structural diagram showing the calibration device in an application scenario in which substrates are separated from each other.

FIG. 7A is a schematic top view of a portion of the calibration device in an application scenario according to one embodiment of the present disclosure.

FIG. 7B is a schematic top view of a portion of the calibration device in another application scenario according to one embodiment of the present disclosure.

FIG. 8 is a schematic flowchart of a method for determining position-attitude information by a mobile device according to one embodiment of the present disclosure.

FIG. 9 is a schematic flowchart of S81 of the method for determining position-attitude information by the mobile device according to one embodiment of the present disclosure.

FIG. 10 is a schematic flowchart of a method for determining position-attitude information by a mobile device according to another embodiment of the present disclosure.

FIG. 11 is a schematic structural diagram of a mobile device according to one embodiment of the present disclosure.

FIG. 12 is a schematic structural diagram of a control device according to one embodiment of the present disclosure.

FIG. 13 is a schematic structural diagram of a storage device according to one embodiment of the present disclosure.

### DETAILED DESCRIPTION OF THE EMBODIMENTS

In order to more clearly explain the embodiments of the present disclosure, technical solutions of the present disclosure will be described in detail with reference to the drawings.

Terms used in the specification of the present disclosure are only for descriptive purposes and are not intended to limit the present disclosure. Singular forms “a,” “the,” and “this” used in the embodiments of the present disclosure and claims are also intended to include plural forms unless the context clearly indicates other meanings. A term of “and/or” includes any and all combinations of one or more related items described. A term of “a plurality of” indicates at least two. It should be noted that, in the case of no conflict, the features of the following examples and implementations can be combined with each other.

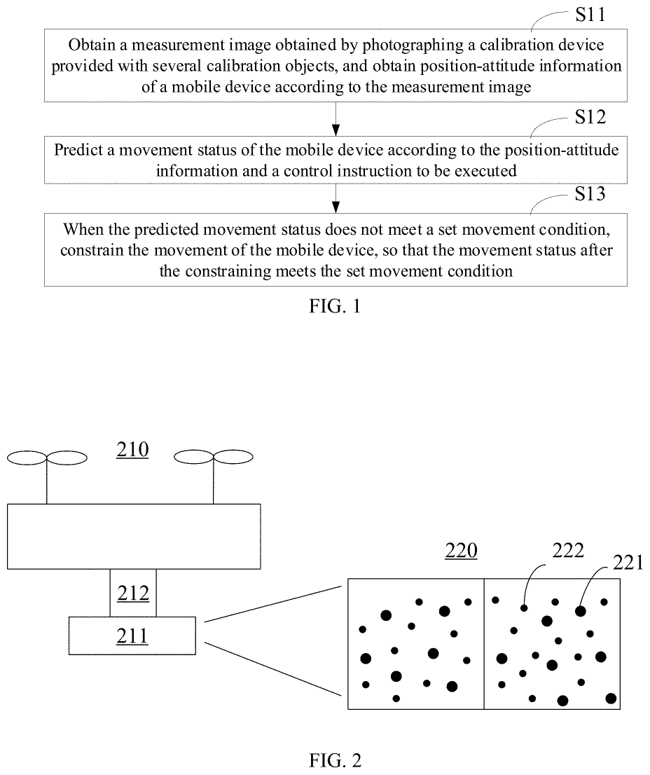

FIG. 1 is a schematic flowchart of a method for controlling a mobile device according to one embodiment of the present disclosure. The control method is executed by the mobile device. The mobile device may be any device that can move under an action of an external force or relying on a self-provided power system, e.g., an unmanned aerial vehicle (UAV), an unmanned vehicle, a mobile robot, etc. In some embodiments, the control method includes the following processes.

At S11, a measurement image obtained by photographing a calibration device provided with several calibration objects is obtained, and position-attitude information of the mobile device is obtained according to the measurement image.

In some embodiments, the calibration device can be disposed on a ground, e.g., laid on the ground, or the calibration device can be perpendicular to the ground. When the mobile device is moving on or flying above the ground where the calibration device is disposed, the calibration device can be observed through a photographing device provided at the mobile device (i.e., mobile platform). As shown in FIG. 2, during the movement of the mobile device 210, the photographing device 211 provided at the carrier device 212 of the mobile device 210 is configured to shoot the pre-disposed calibration device 220 to obtain a measurement image. The calibration device 220 may be any calibration device with an image calibration function, and the calibration device is provided with several calibration objects 221 and 222. Correspondingly, the measurement image includes image areas representing the calibration objects, and the image areas are also referred to as image objects of the calibration objects.

In some embodiments, one or a plurality of calibration devices may be provided, and relative positions between the plurality of calibration devices are fixed. The relative positions between the plurality of calibration devices do not need to be obtained in advance, and can be obtained using a calibration method when the position-attitude information is subsequently calculated. In some embodiments, the calibration object may include a dotted area including dots randomly distributed across the calibration device (referred to as random dots), or a two-dimensional code, etc. In some embodiments, the image calibration device may include a calibration board. The random dot may be round or another shape, and the random dots at the calibration device may be of the same size or different sizes. As shown in FIG. 2, the calibration device 220 is provided with random dots 221 and 222 with two sizes. The two-dimensional code can be a QR code or a Data Matrix code, etc. Further, the calibration device may also include as described in the following embodiment.

After obtaining the measurement image, the mobile device can obtain the position-attitude information of the mobile device according to the measurement image. For example, the mobile device detects the image object of the calibration object in the measurement image, and can determine the position-attitude information of the mobile device according to the detected image object. The position-attitude information of the mobile device can refer to the position-attitude information of the mobile device relative to the calibration device. Since the calibration object of the calibration device is an object with an obvious characteristic, the mobile device can detect the image object of the calibration object from the measurement image using a dot extraction (i.e., blob detector) algorithm or other detection algorithms according to the characteristic of the calibration object. After detecting the image object, the mobile device can extract a characteristic parameter of each image object from the measurement image and match with a pre-stored characteristic parameter of the calibration object of the calibration device to determine the calibration object of each image object. The mobile device then calculates and obtains the position-attitude information of the mobile device using a relative position-attitude calculation algorithm such as a perspective n points (PnP) algorithm according to the determined calibration object. Further, the acquisition of the position-attitude information in this process may be implemented by executing the processes of the method embodiments for determining the position-attitude information shown in FIGS. 8-10 and described below.

At S12, a movement status of the mobile device is predicted according to the position-attitude information and a control instruction to be executed.

After obtaining the position-attitude information, the mobile device can obtain its own current position-attitude. The position-attitude information includes position information and/or attitude information, so a movement status of the mobile device can be predicted according to the position-attitude information and a control instruction to be executed, that is, a movement status of the mobile device in subsequent time can be predicted. Further, the mobile device can predict a movement track of the mobile device according to the position-attitude information and the control instruction to be executed, and thereby obtaining the movement status of the mobile device on the predicted movement track. For example, during obtaining the attitude information and the position information, the mobile device obtains a current speed through a provided sensor, and predicts a movement speed in a subsequent period of time according to a speed requirement in the control instruction to be executed and the current speed. The mobile device then predicts a movement position in the subsequent period of time according to the predicted movement speed and a direction requirement in the control instruction to be executed, so that the movement track and the movement speed corresponding to the movement track in the next period of time can be obtained based on the movement position and the movement speed. The mobile device obtains the movement status on the movement track according to the movement track and the movement speed corresponding to the movement track. The mobile device can perform the prediction by using a prediction model or an algorithm.

The control instruction to be executed is configured to control the movement status of the mobile device, and may be generated by the mobile device or sent by a control device to the mobile device. The control device described may be any control device, e.g., a remote control device, a somatosensory control device, etc.

The movement status of the mobile device may include one or more of a movement speed, a relative position between the mobile device and the object, a movement acceleration, and a movement direction. For example, the object is an edge position of a set range. In some embodiments, the object may be preset, and the mobile device has the pre-stored position information of the object. The position information of the mobile device can be predicted according to the position-attitude information and the control instruction to be executed, and then the position information of the mobile device and the object can be compared to obtain the relative position between the mobile device and the object.

In some embodiments, the mobile device is an unmanned aerial vehicle (UAV), and the movement status is a flight status of the UAV. The flight status may include one or more of a flight speed, a relative position between the mobile device and the object, a flight acceleration, and a flight direction.

It should be noted that in the process at S11, the mobile device can continuously obtain its position-attitude information during the movement. For example, the mobile device repeatedly photographs the calibration device at a plurality of moments to obtain a plurality of measurement images, and obtains the position-attitude information of the mobile device according to each measurement image as described above, thereby obtaining the position-attitude information of the mobile device at a plurality of moments. In some embodiments, the process at S12 may include the mobile device predicting the movement status of the mobile device according to the position-attitude information at a plurality of moments and the control instructions to be executed.

At S13, when the predicted movement status does not meet a set movement condition, the movement of the mobile device is constrained, so that the movement status after the constraining meets the set movement condition.

In some embodiments, the mobile device pre-stores the set movement condition. After predicting the movement status, the mobile device determines whether the predicted movement status meets the set movement condition. If the predicted movement status meets the set movement condition, the mobile device can move according to the control instruction to be executed. If the predicted movement status does not meet the set movement condition, the mobile device does not move directly according to the control instruction to be executed, and the movement of the mobile device is constrained according to the predicted movement status, so that the movement status after the constraining meets the set movement condition. In some embodiments, the mobile device can constrain the movement of the mobile device by directly generating a new control instruction. In some embodiments, the mobile device can control the controlling of the control device and constrain the movement of the mobile device through the constrained operation of the control device. In some embodiments, the mobile device can constrain the movement of the mobile device by executing the two control methods described above simultaneously to constrain the movement of the mobile device.

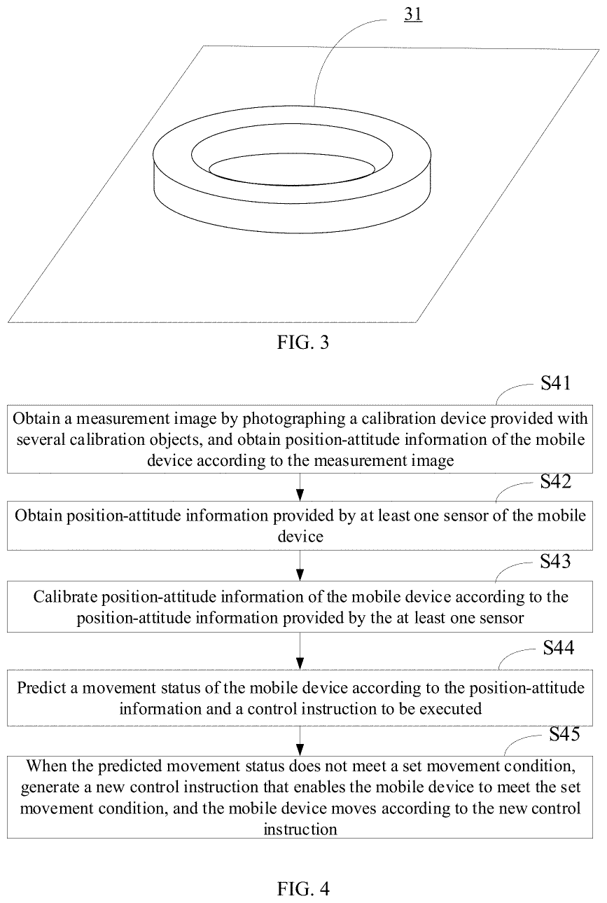

The set movement condition may include a limit on the movement status of the mobile device, e.g., a speed limit, a position limit, or an attitude limit. In some embodiments, the set movement condition is that the mobile device keeps moving within a set range. Correspondingly, the movement status obtained by the mobile device may include the speed of the mobile device and the relative position between the mobile device and the edge position of the set range. The mobile device determines whether the mobile device is still within the set range according to the predicted speed and relative position. If it is still within the set range, it is indicated that the set movement condition is met, otherwise the set movement condition is not met. It can be understood that the set range described above may be two-dimensional or three-dimensional. The two-dimensional set range is a range on a horizontal plane. The three-dimensional set range is a range on a horizontal plane and a vertical plane, that is, a range in a height direction added compared to the two-dimensional set range, e.g., the set range 31 shown in FIG. 3. The three-dimensional set range includes but is not limited to a cube, a cylinder, or a cylindrical ring.

In some embodiments, the set range may be determined according to data planned on a map or a disposition position of the calibration device. For example, before the process at S11, the mobile device receives information of the set range sent by a user device, and determines the set range in the set movement condition according to the information of the set range. The information of the set range is obtained by the user device according to a user selection on a global map displayed by the user device, where the global map is built and generated by the user device using position information of a pattern tool (an example of the calibration device) or a global positioning system (GPS). Further, the user can generate a graph of the set range at the global map by pointing, drawing a line, or inputting a geometric attribute value at the displayed global map. The geometric attribute value includes a vertex coordinate of a cube or a central axis position and a radius of a cylinder, etc. The user device obtains the position data of the graph of the set range according to the map data, and send the position data as the information of the set range to the mobile device. After obtaining the information of the set range, the mobile device can display the position of the set range in combination with the map, and can determine the relative position between the current position and the set range. The mobile device then flies to a starting point of the set range through a manual operation or an automatic operation, so as to start moving within the set range. In some embodiments, the information of the set range is a coverage range of the calibration device determined according to the disposition position of the calibration device. The position data of the coverage range is directly determined as the information of the set range, or the coverage range of each calibration device is provided to the user to select or splice and the position data of the coverage range finally selected or spliced by the user is determined as the information of the set range. It can be understood that the information of the set range can also be obtained by the mobile device directly executing the execution processes of the user device described above, and is not limited here.

It can be understood that the set movement condition may be preset by the user and sent to the mobile device, or may be generated by the mobile device according to environmental information and user need, which is not limited here.

In the present disclosure, the mobile device obtains the measurement image by photographing the calibration device, and obtains the position-attitude information according to the measurement image, and thereby achieving simple and low-cost positioning. Further, the mobile device predicts the movement status according to the position-attitude information and the control instruction. When the predicted movement status does not meet the set movement condition, the mobile device does not execute the control instruction but constrains the movement of the mobile device, so that the movement status after the constraining meets the set movement condition, which enables the mobile device to autonomously constrain the movement and avoids a situation where a movement status does not meet a requirement, and improves the safety of the movement of the mobile device. Further, when the control instruction is sent by the control device, that is, the mobile device is controlled by the control device to realize movement, the mobile device can also autonomously constrain the movement. For example, the constraining can be realized by self-generating a new control instruction or by reversely controlling the control device. A shared control of the mobile device (i.e., a dual control method with the control device for primary control and the mobile device itself for secondary control) can be realized, ensuring an accurate movement of the mobile device.

FIG. 4 is a schematic flowchart of a method for controlling a mobile device according to one embodiment of the present disclosure. The control method shown in FIG. 4 can be executed by the mobile device, and includes the following processes.

At S41, a measurement image is obtained by photographing a calibration device provided with several calibration objects, and position-attitude information of the mobile device is obtained according to the measurement image. The process at S11 described above can be referred to for the specific description of the process at S41.

At S42, position-attitude information provided by at least one sensor of the mobile device is obtained, where the at least one sensor includes at least one of a camera, an infrared sensor, an ultrasonic sensor, or a laser sensor. The position-attitude information provided by the at least one sensor is also referred to as “sensor position-attitude information.”

At S43, position-attitude information of the mobile device is calibrated according to the position-attitude information provided by the at least one sensor. In some embodiments, in order to improve the accuracy of the position-attitude information, after obtaining the position-attitude information according to the measurement image, the mobile device calibrates the position-attitude information obtained according to the measurement image with a combination with the position-attitude information output by the sensor, and executes the following processes using the calibrated position-attitude information. For example, when a difference between the position-attitude information obtained according to the measurement image and the position-attitude information output by the sensor exceeds a set degree, a weighted average of the two position-attitude information is determined as a final position-attitude information of the mobile device.

At S44, a movement status of the mobile device is predicted according to the position-attitude information and a control instruction to be executed. The process at S12 described above can be referred to for the specific description of the process at S44.

At S45, when the predicted movement status does not meet a set movement condition, a new control instruction that enables the mobile device to meet the set movement condition is generated, and the mobile device moves according to the new control instruction. In some embodiments, the mobile device may adopt a law for setting the control, and generates the new control instruction according to the predicted movement status and the set movement condition. For example, the mobile device designs the law for setting the control using a virtual force field method, an artificial potential filed method, or other methods in advance. When the movement status is predicted according to the above described measurement image, the preset movement status and the set movement condition are mapped to obtain the new control instruction. In this way, a movement actually executed by the mobile device can still meet the set movement condition.

In an application scenario, the mobile device is an unmanned aerial vehicle (UAV) that uses a flight range as a flight track, and the set movement condition is that the mobile device keeps moving within the flight range. The mobile device operates in an external control mode, e.g., moving in response to a control instruction sent by the control device. During an operation, the mobile device photographs the calibration device on a ground to obtain a measurement image, and obtains current position-attitude information of the mobile device according to the measurement image. According to the control instruction to be executed sent by the control device and the obtained position-attitude information, a model is established to predict the flight track of the mobile device, and a relative position between the predicted flight track and the edge of the flight range and a flight speed are obtained. When it is determined that the relative position and the speed do not meet the set movement condition, the mobile device maps the relative position and the speed information with the content of the set movement condition to obtain a new control instruction according to a law for setting the control. The mobile device does not execute the control instruction to be executed sent by the control device but executes the new control instruction to move, to avoid the mobile device flying out of the flight range. Further, in this application scenario, the mobile device can be primarily controlled by the control device and perform a secondary control by itself to realize a shared control of the UAV. The mobile device not meeting a set requirement can be avoided, and the user of the control device can have a deep mobile operation experience in a limited space (e.g., the set range described above) thanks to the security. This application scenario realizes a virtual track (e.g., the set range) crossing in the shared control mode by the control device and the autonomous mobile control.

In some embodiments, constraining the movement of the mobile device is achieved by directly controlling the mobile device. In some embodiments, the mobile device can control the controlling of the control device and achieve constraining the movement of the mobile device through the constrained operation of the control device. For example, constraining the movement of the mobile device so that the movement status after the constraining meets the set movement condition may include sending a feedback instruction to the control device to constrain the operation of the control device, where the feedback instruction may include the movement status predicted by the mobile device. The control instruction generated by the constrained control enables the mobile device to perform a movement that meets the set movement condition. The control instruction generated due to the operation of the control device can only make the movement correspondingly executed by the mobile device meet the set movement condition, so that the movement performed by the mobile device by again receiving the control instruction sent by the control device and executing the control instruction still meets the set movement condition.

In some embodiments, constraining the operation of the control device may include the control device responding to the feedback instruction to control an input component for inputting an instruction, so that an operation input by the user through the input component can realize that the mobile device meets the set movement condition. Further, in some embodiments where the user implements the input of the operation information of the movement through the input component, when detecting that the user performs an operation on the input component that causes the mobile device not to meet the set movement condition, the control device generates a resistance opposite to the current operation direction on the input component. In some embodiments, an allowable operation range of the input component is determined according to the feedback instruction, to restrict the user to operate within the allowable operation range. In some embodiments, the overall operation range is not limited, but a movement displacement of the mobile device corresponding to a unit operation is decreased, thereby achieving constraining of the operation of the control device, and can also remind the user of a current improper operation.

In another application scenario, the mobile device is an unmanned aerial vehicle (UAV) that uses a flight range as a flight track. The input component of the control device is a joystick. The set movement condition is that the mobile device keeps moving within the flight range. The mobile device operates in an external control mode. As described in the above application scenario, the mobile device obtains the relative position between the predicted flight track and the edge of the flight range and the flight speed. When it is determined that the relative position and the speed do not meet the set movement condition, the mobile device maps the relative position and the speed information to obtain a feedback instruction according to a law for setting the control, and sends the feedback instruction to the control device. The control device determines operations of the joystick that can make the mobile device meet the set movement condition according to the feedback instruction, that is, when the mobile device executes a control instruction generated by the joystick, a corresponding movement status meets the set movement condition. When it is detected that an operation performed by the user on the joystick does not belong to the above described determined operations, the joystick is controlled to generate a resistance that hinders the current operation of the user, so that the user cannot perform the current operation, thereby ensuring that movements executed by the mobile device according to received following control instructions all meet the set movement condition, and avoiding the mobile device from flying out of the flight range. In this application scenario, the mobile device reversely controls the control device to constrain the control device to only perform an operation that meets the set requirement, which achieves a shared control of the UAV and avoids the mobile device from not meeting the set requirement, thereby improving the movement security of the mobile device controlled by the user and enhancing the mobile operation experience.

Further, in some embodiments where the set movement condition is that the mobile device keeps moving within a set range, when the predicted movement status does not meet the set movement condition (i.e., the mobile device moves beyond the set range if executing the control instruction to be executed), the mobile device can further simulate collision and bounce data of the mobile device with the edge of the set range, and display a scenario of collision and bounce of the mobile device with the edge of the set range in a map or other graphs displayed by itself according to the collision and bounce data. In some embodiments, the mobile device sends the collision and bounce data to the control device, to display the scenario of the collision and bounce of the mobile device with the edge of the set range in a map or other graphs displayed by the control device according to the collision and bounce data.

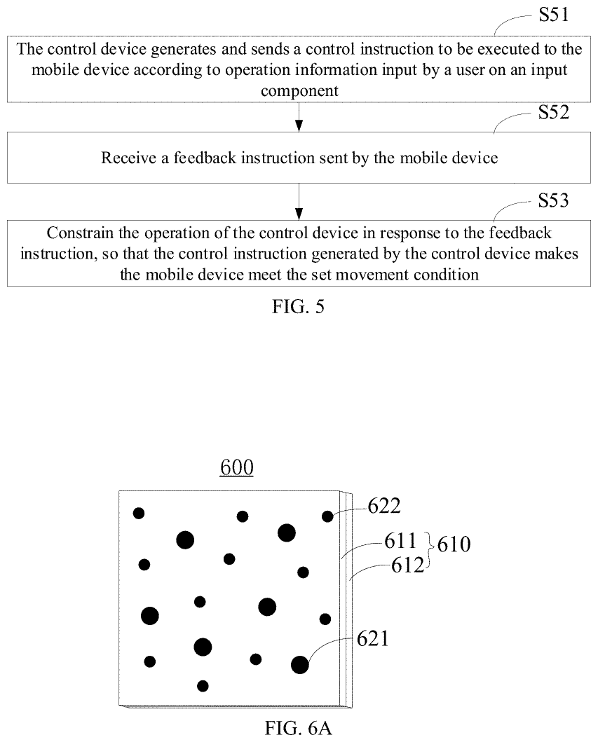

FIG. 5 is a schematic flowchart of a method for controlling a mobile device according to one embodiment of the present disclosure. The control method shown in FIG. 5 can be executed by a control device, e.g., a remote control device, a somatosensory control device, etc. For example, the remote control device is a hand-held remote controller provided with a joystick. The somatosensory control device is a device that implements a corresponding control by sensing an action or voice of a user, e.g., flight glasses for controlling flight or photographing of a UAV. In some embodiments, the control method includes the following processes.

At S51, the control device generates and sends a control instruction to be executed to the mobile device according to operation information input by a user on an input component.

For example, the control device is a remote control device, and the input component is a joystick provided at the remote control device. The user operates the joystick, and the joystick generates a corresponding operation signal. The remote control device then generates a corresponding control instruction to be executed according to the operation signal, and sends the control instruction to the mobile device. After receiving the control instruction to be executed, the mobile device executes the embodiment method to realize a shared control with the remote control device and the mobile device itself, to ensure that a movement meets a requirement.

At S52, a feedback instruction sent by the mobile device is received.

The feedback instruction is sent by the mobile device when predicting a movement status according to position-attitude information and the control instruction to be executed and determining the predicted movement status does not meet a set movement condition. The relevant description of the above described embodiment can be referred to for a description of the feedback instruction.

At S53, the operation of the control device is constrained in response to the feedback instruction, so that the control instruction generated by the control device makes the mobile device meet the set movement condition.

The control device can adopt any constraining method that ensures that the control instruction sent to the mobile device can make the movement status of the mobile device meet the set movement condition.

In some embodiments, the operation of the control device can be controlled by controlling an operation of an input component. In some embodiments, constraining the operation of the control device in response to the feedback instruction includes controlling the input component in response to the feedback instruction, so that the operation input by the user through the input component can realize that the mobile device meets the set movement condition.

Further, in some embodiments where the input component is moved by the user to implement the input of the operation information, the input component can be a joystick for example. Controlling the input component in response to the feedback instruction includes when it is detected that the user performs an operation on the input component that causes the mobile device not to meet the set movement condition, the control device generates a resistance opposite to the current operation direction of the user on the input component, or the control device determines an allowable operation range of the input component according to the feedback instruction, to restrict the user to operate within the allowable operation range, where the allowable operation range is a set of operations that ensure movement statuses due to the mobile device executing corresponding control instructions to meet the set movement condition.

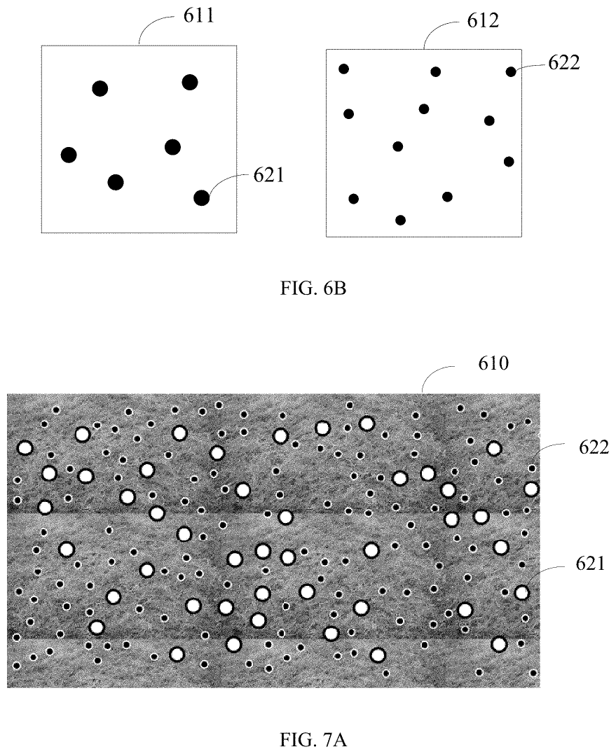

FIG. 6A is a schematic structural diagram of a calibration device according to one embodiment of the present disclosure. The calibration device 600 is the calibration device used in the mobile device control method of the present disclosure. The calibration device 600 includes a carrier device 610 and at least two calibration objects 621 and 622 of different sizes. The at least two calibration objects of different sizes include two calibration objects with two sizes for illustrative purpose, that is, the at least two calibration objects of different sizes include a first-size calibration object and a second-size calibration object.

In some embodiments, the carrier device 610 includes one or more substrates, and each substrate includes, e.g., a metal plate, or a non-metal plate such as a cardboard or a plastic plate, etc. The calibration objects 621 and 622 can be provided at the substrate(s) by etching, coating, printing, displaying, etc. The carrier device 610 may be a plurality of substrates stacked, and each substrate is separately provided with one or more calibration objects 621 and 622 with different sizes. As shown in FIG. 6B, the substrate 611 is provided with the first-size calibration object 621, and the substrate 612 is provided with the second-size calibration object 622. Positions of the calibration objects at different substrates are different, and the other substrates except for the bottommost substrate are all set to be transparent, so that the calibration objects 621 and 622 at each substrate can be observed from a front of the carrier device 610 after the plurality of substrates are stacked to form the carrier device 610, as shown in FIG. 6A. In some embodiments, the carrier device 610 may include a display device, e.g., a display screen or a projection screen, etc. The calibration objects 621 and 622 may be displayed on the carrier device 610. For example, the calibration objects 621 and 622 are displayed on the carrier device 610 through a control device or a projector. The carrier device 610, and the means for providing the calibration objects 621 and 622 at the carrier device 610 are not limited in the present disclosure.

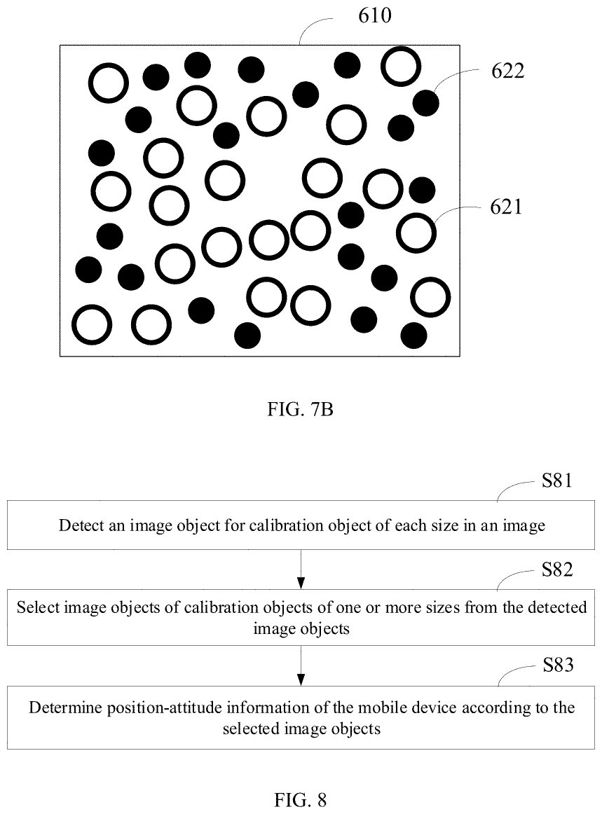

In addition, the calibration device further includes an image provided at the carrier device 610, where the image is used as a background image of the calibration objects 621 and 622. The image can be a textured image, as shown in FIG. 7A. The image can also be a solid color image with a color different from that of the calibration objects 621 and 622, as shown in FIG. 7B. Correspondingly, when the carrier device 610 is a plurality of substrates stacked, the image is provided at the bottommost substrate to form the background image of the calibration objects 621 and 622 of all the substrates.

In some embodiments, the calibration object may include a dotted area with randomly-distributed dots, referred to as random dots, and the calibration object may be set to any shape, e.g., a circle, a square, or an ellipse, etc. The calibration objects have at least two sizes, with each size corresponding to a plurality of calibration objects. The calibration device of the present disclosure includes calibration objects with different sizes. Even when the distance between the mobile device and the calibration device is large, the calibration object with large size can still be detected. When the distance between the mobile device and the calibration device is small, a certain amount of the calibration objects with small size can still be detected. The calibration objects of different sizes can be selected in different scenarios to determine the position-attitude information of the mobile device, so as to ensure the reliability and robustness of the positioning.

In order to further avoid the influence of the distance of the mobile device on determining the position-attitude information, densities of the calibration objects of different sizes 621 and 622 at the carrier device 610 are also different. For example, the density of the calibration object with a small size is greater than the density of a calibration object with a large size. When the distance between the mobile device and the calibration device is small, since the density of the calibration object with a small size is large, a sufficient number of calibration objects with small size can be detected, and the position-attitude information of the mobile device can be determined.

Further, in order to improve the accuracy of the detection of the calibration object when the position-attitude information of the mobile device is determined, at least one calibration object 621 or 622 at the carrier device 610 is provided with an outer ring, and the color of the outer ring is different from the color of the inside of the ring. For example, the outer ring is black and the inside of the outer ring is white, or the outer ring is white and the inside of the outer ring is black. Since the color of the outer ring is different from the color of the inside of the outer ring, the contrast is relatively high, the calibration object can be detected from the image based on the color difference between the outer ring and the inside of the outer ring. The detection of the calibration object is not affected no matter what content is provided at the background image of the calibration object, and the requirement for the background image of the calibration object is decreased, and hence the accuracy and reliability of the detection is improved. In some embodiments where the background image of the calibration object has relatively serious interference, a grayscale difference between the outer ring and the inside of the ring can be set to be greater than a preset threshold to improve the contrast between the outer ring and the inside of the outer ring.

In addition, at the carrier device 610, the color of the central part of at least one calibration object 621 or 622 is different from the color of central part of another calibration object 622 or 621, so that the calibration objects with different sizes can be distinguished according to the color of the central parts of the calibration objects. In some embodiments, with reference to FIG. 7A, the carrier device 610 is provided with calibration objects 621 and 622 of two different sizes that are each provided with a circular outer ring. The central part (i.e., the inside of the outer ring) of the calibration object 621 is white, and the outer ring is black. The central part (i.e., the inside of the outer ring) of the calibration object 622 is black, and the outer ring is white. In some embodiments, with reference to FIG. 7B, the carrier device 610 is provided with calibration objects 621 and 622 with two different sizes. The calibration object 621 is provided with a circular outer ring, and the calibration object 622 is not provided with an outer ring. The central part (i.e., the inside of the outer ring) of the calibration object 621 is white, and the outer ring is black. The central part (i.e., the inside of the outer ring) of the calibration object 622 is black.

FIG. 8 is a schematic flowchart of a method for determining position-attitude information of a mobile device according to one embodiment of the present disclosure. The method is executed by the mobile device, and includes the following processes.

At S81, an image object for calibration object of each size in an image is detected.

In some embodiments, after obtaining the image obtained by photographing the image calibration device, the mobile device detects the image objects of the calibration objects from the image, and further determines the correspondence between each image object and the size, so as to determine to which calibration object of a specific size does each image object corresponds. The image object is an image area of the captured calibration object in the image. The mobile device can detect the image objects of calibration objects of different sizes from the image according to characteristics of the calibration objects.

At S82, image objects of calibration objects of one or more sizes are selected from the detected image objects.

After detecting the above described image objects from the image, the mobile device selects image objects of calibration objects of one or more sizes from the detected image objects according to a preset strategy. The preset strategy can also be dynamically selecting different image objects of the calibration objects of one or more sizes according to different actual situations.

At S83, position-attitude information of the mobile device is determined according to the selected image objects.

For example, after selecting the image objects, the mobile device extracts a characteristic parameter of each selected image object from the image and matches with a pre-stored characteristic parameter of the calibration object of the calibration device to determine the calibration object of each selected image object. The mobile device then calculates and obtains the position-attitude information of the mobile device using a relative position-attitude calculation algorithm such as a perspective n points (PnP) algorithm according to the determined calibration object.

In some embodiments, the above described information may not be able to be determined according to the selected image objects through the process at S82. The process at S82 can be re-executed to re-select image objects of calibration objects of one or more sizes, and at least some of the sizes of the re-selected image objects are different from the sizes of the previously selected image objects. The mobile device may again determine the position-attitude information of the mobile device according to the re-selected image objects. This process is repeated until the position-attitude information of the mobile device can be determined.

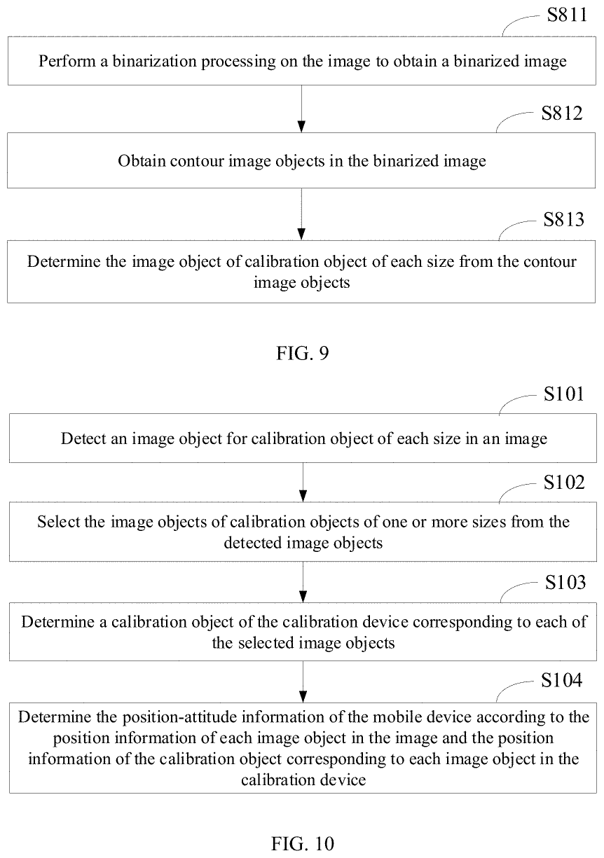

FIG. 9 is a schematic flowchart showing further details of the process at S81 in FIG. 8 according to another embodiment of the present disclosure. As shown in FIG. 9, the process at S81 shown in FIG. 8 executed by the mobile device include the following sub-processes.

At S811, a binarization processing is performed on the image to obtain a binarized image.

In some embodiments, in order to eliminate a possible interference source in the image (e.g., an image with texture in the calibration device) that interferes with the detection of the calibration object, the image can be binarized and the image object of the calibration object can be detected and obtained according to the processed image. The image can be binarized through a fixed threshold or a dynamic threshold.

At S812, contour image objects in the binarized image are obtained.

For example, the binarized image after the process at S811 described above includes a plurality of contour image objects, where the contour image objects include contour images corresponding to the calibration objects in the calibration device, i.e., image objects of the calibration objects. In some embodiments, the contour image objects include a contour image of an object corresponding to the interference source, i.e., an image object of the interference source.

At S813, the image object of calibration object of each size is determined from the contour image objects.

The mobile device needs to determine which contour objects are the image objects of the calibration objects from the obtained contour image objects. Since the calibration objects of the calibration device all have clear characteristics, the image objects of the calibration objects should theoretically meet requirements of the characteristics of the corresponding calibration objects. The mobile device can determine whether the characteristic parameter corresponding to each contour image object meets a preset requirement, and hence can determine the image object of calibration object of each size from the contour image objects whose characteristic parameters meet the preset requirement.

In some embodiments, the calibration object has a clear shape characteristic, and whether a contour image object is an image object of the calibration object can be determined according to a shape characteristic parameter of the contour image object. For example, the mobile device determines the shape characteristic parameter of each contour image object, determines whether the shape characteristic parameter corresponding to each contour image object meets a preset requirement, and determines the image object of calibration object of each size from the contour image objects whose shape characteristic parameters meet the preset requirement. The shape characteristic parameter may include one or more of roundness, area, and convexity, etc. The roundness refers to a ratio of the area of the contour image object to the area of an approximate circle of the contour image object. The convexity refers to a ratio of the area of the contour image object to the area of an approximate polygonal convex hull of the contour image object. The preset requirement may include whether the shape characteristic parameter of the contour image object is within a preset threshold, and it is determined that the contour image object is the image object of the calibration object if the shape characteristic parameter of the contour image object is within the preset threshold. For example, the preset requirement is that at least two of the roundness, area, and convexity of the contour image object are within a specified threshold, and the mobile device determines contour image objects with at least two of the roundness, area, and convexity within the specified threshold as the image objects of the calibration objects, and thereby determining the image object of calibration object of each size from the determined image objects of the calibration objects.

In some embodiments, the mobile device may determine a size corresponding to the image object of each calibration object according to the size characteristic of the image object of the calibration object. For example, after determining the contour image objects that meet the preset requirement as the image objects of the calibration objects, the mobile device compares the size characteristic of each determined image object with the pre-stored size characteristic of calibration object of each size, and further determines each image object as the image object of the calibration object with same or similar size characteristics. The size characteristic can be the area, perimeter, radius, side length, etc. of the image object or the calibration object.

When a color of a center portion of a calibration object of one size is different from a color of a center portion of a calibration object of another size in the calibration device, the mobile device can also determine the size corresponding to the image object of each calibration object according to a pixel value inside the image object of the calibration object. For example, after determining the contour image objects that meet the preset requirement as the image objects of the calibration objects, the mobile device determines the pixel values inside the contour image objects that meet the preset requirement, and determines the image object of calibration object of each size according to the pixel values and the pixel value characteristic inside calibration object of each size. The mobile device may pre-store the pixel value characteristic inside calibration object of each size. For example, the pixel value characteristic inside the first-size calibration object of the calibration device pre-stored by the mobile device is 255, and the pixel value characteristic inside the second-size calibration object of the calibration device pre-stored by the mobile device is 0. For contour image objects that meet the preset requirement, the mobile device further detects whether the pixel value inside the contour image object is 0 or 255. If the pixel value is 0, the contour image object is the image object of the second-size calibration object. If the pixel value is 255, the contour image object is the image object of the first-size calibration object.

FIG. 10 is a schematic flowchart of a method for a mobile device to determine position-attitude information according to another embodiment of the present disclosure. In some embodiments, the method is executed by the above described mobile device and includes the following processes.

At S101, an image object for calibration object of each size in an image is detected. The relevant description of the process at S81 can be referred to for a specific description of the process at S101.

At S102, the image objects of calibration objects of one or more sizes are selected from the detected image objects.

In some embodiments, as described above, the image objects of the calibration objects of one or more sizes can be selected from the detected image objects according to a preset strategy. The selection can be implemented through the following methods in a practical application.

In some embodiments, the image objects of the calibration objects of one or more sizes can be selected from the detected image objects according to sizes of historical matching calibration objects.

The sizes of the historical matching calibration objects are the sizes of calibration objects in a historical image obtained by photographing the calibration device that are selected and capable of determining the position-attitude information of the mobile device. In some embodiments, the historical image(s) include one or more image frames preceding a current image frame. The above-described “capable of determining the position-attitude information of the mobile device” refers to successfully determining that the position-attitude information of the mobile device is obtained. For example, after performing the processing as described in the positioning method to the previous image frame photographed by the calibration device, the mobile device eventually successfully determined and obtained the position-attitude information of the mobile device according to an image object of a first-size calibration object in the previous image frame, i.e., the size of the historical matching calibration object is the first size, then for the image object detected from the current image frame, the image object of the first-size calibration object is selected to determine the position-attitude information of the mobile device.

In some embodiments, the image objects of the calibration objects of one or more sizes can be selected from the detected image objects according to the number of the image object of calibration object of each size. An example is described below, where the calibration device includes a first-size calibration object and a second-size calibration object, and the first size is larger than the second size. The mobile device determines a ratio of the number of detected image objects of the first-size calibration object to the total number of detected image objects. When the determined ratio is greater than or equal to a first set ratio, the image object of the first-size calibration object is selected. When the determined ratio is smaller than the first set ratio and greater than or equal to a second set ratio, the image object of the first-size calibration object and the image object of the second-size calibration object are selected. When the determined ratio is smaller than the second set ratio, the image object of the second-size calibration object is selected. In some embodiments, the mobile device separately obtains the number of the image object of the first-size calibration object and the number of the image object of the second-size calibration object, and selects the image object of calibration object of one size with a larger number.

In some embodiments, the image objects of the calibration objects of one or more sizes can be selected from the detected image objects according to historical distance information, where the historical distance information is distance information of the mobile device relative to the calibration device determined according to a historical image obtained by photographing the calibration device. An example is described below, where the calibration device includes a first-size calibration object and a second-size calibration object, and the first size is larger than the second size. The mobile device obtains the distance information of the mobile device relative to the calibration device determined according to a previous image frame obtained by photographing the calibration device. When the determined distance information is greater than or equal to a first set distance, the image object of the first-size calibration object is selected. When the determined distance information is smaller than the first set distance and greater than or equal to a second set distance, the image object of the first-size calibration object and the image object of the second-size calibration object are selected. When the determined distance information is smaller than the second set distance, the image object of the second-size calibration object is selected.

It can be understood that the mobile device can also comprehensively select the image objects of the calibration objects of one or more sizes from the detected image objects according to two or more of above described methods, which is not limited here.

Further, in some embodiments where the position-attitude information of the mobile device cannot be determined according to the selected image objects, the mobile device may re-select image objects of the calibration objects of one or more sizes, so as to determine the position-attitude information of the mobile device according to the re-selected image objects. This process is repeated until the position-attitude information of the mobile device can be determined according to the selected objects. The sizes of the image objects re-selected each time are at least partially different from the sizes of the image objects selected each time previously. In addition, the mobile device can obtain the next image frame of the calibration device captured by the photograph device, and then select the image objects of the calibration objects of one or more sizes from the image according to the above described methods.

In some embodiments, a selection order of the detected image objects is determined, and the image objects of the calibration objects of one or more sizes are selected from the detected image objects according to the selection order. In some embodiments, in order to reduce the number of the selection, the selection order may be determined according to one or more of the above described sizes of the historical matching calibration objects, the number of the image object of calibration object of each size, and the historical distance information. The method is illustrated below with reference to examples where the calibration device includes a first-size calibration object and a second-size calibration object.

In some embodiments, if the mobile device selects the image object of the first-size calibration object in the previous frame, that is, the size of the historical matching calibration object is the first size, the selection order is the image object of the first-size calibration object, the image object of the first-size calibration object and the image object of the second-size calibration object, and then the image object of the second-size calibration object. In some embodiments, the mobile device selects the image object of the first-size calibration object to determine the position-attitude information of the mobile device. If the position-attitude information of the mobile device is successfully determined according to the image object of the first-size calibration object, the movement of the mobile device can be controlled according to the position-attitude information. If the position-attitude information cannot be determined successfully, the image object of the first-size calibration object and the image object of the second-size calibration object are selected to determine the position-attitude information of the mobile device. This process is repeated until the position-attitude information of the mobile device is determined successfully. If the mobile device selects the image object of the second-size calibration object in the previous frame, the selection order is the image object of the second-size calibration object, the image object of the first-size calibration object and the image object of the second-size calibration object, and then the image object of the first-size calibration object.

If the mobile device selects the image object of the first-size calibration object and the image object of the second-size calibration object in the previous frame, and it is detected that the ratio of the detected image object corresponding to the first size is larger than the ratio of the pre-stored first-size calibration object of the calibration device, the selection order is the image object of the first-size calibration object and the image object of the second-size calibration object, the image object of the first-size calibration object, and then the image object of the second-size calibration object. If the mobile device selects the image object of the first-size calibration object and the image object of the second-size calibration object in the previous frame, and it is detected that the ratio of the detected image object corresponding to the second size is larger than the ratio of the pre-stored second-size calibration object of the calibration device, the selection order is the image object of the first-size calibration object and the image object of the second-size calibration object, the image object of the second-size calibration object, and then the image object of the first-size calibration object.

In some embodiments, if the number of the image object of the first-size calibration object is greater than the number of the image object of the second-size calibration object, the selection order is the image object of the first-size calibration object, the image object of the first-size calibration object and the image object of the second-size calibration object, and then the image object of the second-size calibration object. After determining the selection order, the mobile device selects the image object according to the selection order as described above to determine the position-attitude information of the mobile device.

In some embodiments, the first size is larger than the second size. The mobile device obtains the distance information of the mobile device relative to the calibration device determined according to the previous image frame obtained by photographing the calibration device. If the determined distance information is greater than or equal to the first set distance, the selection order is the image object of the first-size calibration object, the image object of the first-size calibration object and the image object of the second-size calibration object, and then the image object of the second-size calibration object. After determining the selection order, the mobile device selects the image object according to the selection order as described above to determine the position-attitude information of the mobile device.

At S103, a calibration object of the calibration device corresponding to each of the selected image objects is determined.

In some embodiments, the mobile device can match the selected image object with the calibration object of the calibration device, that is, can determine a correspondence relationship between each selected image and the calibration object of the calibration device.

Further, the mobile device may determine a position characteristic parameter of each selected image object, obtain a position characteristic parameter of the calibration object of the calibration device, and determine the calibration object of the calibration device corresponding to each of the selected image objects according to the position characteristic parameter of each selected image object and the position characteristic parameter of the calibration object of the calibration device.

The mobile device can pre-store a position characteristic parameter of the calibration object of the calibration device, where the position characteristic parameter may indicate a positional relationship between a certain image object relative to one or more of other image objects, or a positional relationship between a certain calibration object relative to one or more of other calibration objects. In some embodiments, the position characteristic parameter may be a characteristic vector. The mobile device may match the selected image object with the calibration object of the calibration device according to the determined characteristic parameter of the image object and the pre-stored characteristic parameter of the calibration object of the calibration device, and thereby obtaining a calibration object that matches with the selected image object. In some embodiments, when the position characteristic parameter of the image object is same or similar with the pre-stored position characteristic parameter of the calibration object of the calibration device, it can be determined that the image object matches with the calibration object.

In some embodiments, the position characteristic parameter of the calibration object of the calibration device may be pre-stored in a storage device of the mobile device.

In some embodiment, the position characteristic parameter of the calibration object of the calibration device can be stored as a corresponding hash value obtained through a hash operation. Correspondingly, when obtaining the position characteristic parameter of the selected image object, the mobile device performs the same hash operation on the position characteristic parameter of the selected image object to obtain a hash value. When the hash value obtained through the operation is the same as the pre-stored hash value, it can be determined that the corresponding image object matches the corresponding calibration object.

At S104, the position-attitude information of the mobile device is determined according to the position information of each image object in the image and the position information of the calibration object corresponding to each image object in the calibration device.

In some embodiments, the mobile device may use a PnP algorithm to implement determination of the position-attitude information of the mobile device according to the position information of each image object in the image and the position information of the calibration object corresponding to each image object in the calibration device.

In some embodiments, when a plurality of calibration devices are provided, the mobile device matches the position characteristic parameter of the selected image object with the pre-stored position characteristic parameter of the calibration object of each calibration device, so as to determine the calibration device where the calibration object corresponding to the selected image object is located, and thereby determining the calibration object corresponding to the selected image object in the determined calibration device. In addition, the mobile device first obtains the position information of the determined calibration device. In some embodiments, a calibration device pre-storing its position information is provided as a reference calibration device, and the position information of the determined calibration device is obtained according to the position information of the reference calibration device and the relative position between the determined calibration device and the reference calibration device. After obtaining the position information of the determined calibration device, the mobile device may determine the position-attitude information of the mobile device according to the position information of the determined calibration device, the position information of the image object in the image, and the position information of the calibration object of the calibration device corresponding to the image object.

FIG. 11 is a schematic structural diagram of a mobile device 110 according to one embodiment of the present disclosure. The mobile device 110 may be any device that can move under an action of an external force or relying on a self-provided power system, e.g., an unmanned aerial vehicle (UAV), an unmanned vehicle, a mobile robot, etc.

As shown in FIG. 11, the mobile device 110 includes a body 113 and a processor 111, a memory 112, and a photographing device 114 provided at the body 113. The memory 112 and the photographing device 114 are connected to the processor 111.

The body 113 is configured to move in response to a control of the processor 111. In some embodiments, a power apparatus is provided at the body 113 to drive the body to move.

The photographing device 114 is configured to photograph a calibration device provided with several calibration objects to obtain a measurement image.

The memory 112 may include a read-only memory and a random access memory, and provide instructions and data to the processor 111. A part of the memory 112 may further include a non-volatile random access memory.

The processor 111 may be a central processing unit (CPU), a general-purpose processor, a digital signal processor (DSP), an application specific integrated circuit (ASIC), a field-programmable gate array (FPGA), a programmable logic device, a discrete gate or transistor logic device, or a discrete hardware component, etc. The general-purpose processor may be a microprocessor or any conventional processor, etc.

The memory 112 is configured to store a program instruction.

The processor 111 calls the program instruction, and the execution of the program instruction implements the following processes: obtaining a measurement image obtained by photographing a calibration device provided with several calibration objects, and obtaining position-attitude information of a mobile device according to the measurement image; predicting a movement status of the mobile device according to the position-attitude information and a control instruction to be executed; and constraining the movement of the mobile device when the predicted movement status does not meet a set movement condition, so that the movement status after the constraining meets the set movement condition.

In some embodiments, the processor 111 is configured to, during constraining the movement of the mobile device so that the movement status after the constraining meets the set movement condition, generate a new control instruction that enables the mobile device to meet the set movement condition and controls the mobile device to move according to the new control instruction.

Further, to generate the new control instruction that enables the mobile device to meet the set movement condition, the processor 111 can adopt a law for setting the control and generate the new control instruction according to the predicted movement status and the set movement condition.

In some embodiments, to constrain the movement of the mobile device so that the movement status after the constraining meets the set movement condition, the processor 111 sends a feedback instruction to the control device to constrain the operation of the control device, where the control instruction generated by the constrained control enables the mobile device to perform a movement that meets the set movement condition.

Further, the control device may generate the control instruction for the mobile device according to an operation of a user on an input component. Constraining the operation of the control device may include generating a resistance opposite to a current operation direction on the input component when it is detected that the user performs an operation on the input component that causes the mobile device not to meet the set movement condition, or determining an allowable operation range of the input component according to the feedback instruction to restrict the user to operate within the allowable operation range.

In some embodiments, the processor 111 is configured to repeatedly execute obtaining the measurement image obtained by photographing the calibration devices provided with several calibration objects at a plurality of moments, and obtain position-attitude information of the mobile device according to the measurement image, to obtain the position-attitude information of the mobile device at a plurality of moments. To predict the movement status of the mobile device according to the position-attitude information and the control instruction to be executed, the processor 111 can predict the movement status of the mobile device according to the position-attitude information at a plurality of moments and the control instructions to be executed.

In some embodiments, to predict the movement status of the mobile device according to the position-attitude information and the control instruction to be executed, the processor 111 predicts a movement track of the mobile device according to the position-attitude information and the control instruction to be executed, and obtains the movement status of the mobile device on the predicted movement track.

In some embodiments, the control instruction to be executed is sent by the control device or generated by the mobile device.

In some embodiments, the set movement condition is that the mobile device keeps moving within a set range. Further, the movement status may include a speed of the mobile device and a relative position between the mobile device and the edge position of the set range.

In some embodiments, the processor 111 may be further configured to receive information of the set range sent by a user device, where the information of the set range is obtained by the user device according to a user selection on a global map displayed by the user device, and the global map is built and generated by the user device using position information of a pattern tool or a global positioning system (GPS). Further, the set range may be determined according to a disposition position of the calibration device.

In some embodiments, the processor 111 is further configured to obtain position-attitude information provided by at least one sensor of the mobile device, and calibrate position-attitude information of the mobile device according to the position-attitude information provided by the at least one sensor. Further, the at least one sensor includes at least one of a camera, an infrared sensor, an ultrasonic sensor, or a laser sensor.

In some embodiments, the processor 111 is further configured to control the mobile device to move according to the control instruction to be executed when the predicted movement status meets the set movement condition.

In some embodiments, the processor 111 is further configured to simulate collision and bounce data of the mobile device with the edge of the set range when the predicted movement status does not meet the set movement condition, and display a scenario of collision and bounce of the mobile device with the edge of the set range according to the collision and bounce data, or send the collision and bounce data to the control device to display the scenario of the collision and bounce of the mobile device with the edge of the set range in the control device.

In some embodiments, the mobile device is an unmanned aerial vehicle (UAV), and the movement status is a flight status of the UAV.

In some embodiments, to obtain position-attitude information of a mobile device according to the measurement image, the processor 111 obtains an image obtained by photographing a calibration device provided with at least two calibration objects of different sizes, detects an image object for calibration object of each size in the image, selects image objects of calibration objects of one or more sizes from the detected image objects, and determines the position-attitude information of the mobile device according to the selected image objects.

In some embodiments, to detect the image object for calibration object of each size in the image, the processor 111 performs a binarization processing on the image to obtain a binarized image, obtains contour image objects in the binarized image, and determines the image object of calibration object of each size from the contour image objects.

Further, to determine the image object of calibration object of each size from the contour image objects, the processor 111 may determine a shape characteristic parameter of each contour image object, determine whether the shape characteristic parameter corresponding to each contour image object meets a preset requirement, and determine the image object of calibration object of each size from the contour image objects whose shape characteristic parameters meet the preset requirement.

Further, to determine the image object of calibration object of each size from the contour image objects whose shape characteristic parameters meet the preset requirement, the processor 111 may determine pixel values inside the contour image objects that meet the preset requirement, and determine the image object of calibration object of each size according to the pixel values and the pixel value characteristic inside calibration object of each size.

In some embodiments, to determine the position-attitude information of the mobile device according to the selected image objects, the processor 111 determines a calibration object of the calibration device corresponding to each of the selected image objects, and determines the position-attitude information of the mobile device according to the position information of each image object in the image and the position information of the calibration object corresponding to each image object in the calibration device.

Further, in some embodiments, to determine a calibration object of the calibration device corresponding to each of the selected image objects, the processor 111 may determine a position characteristic parameter of each selected image object, and determine the calibration object of the calibration device corresponding to each of the selected image objects according to the position characteristic parameter of each selected image object and a preset position characteristic parameter of the calibration object of the calibration device. The position characteristic parameter of the calibration object of the calibration device may be pre-stored in the above described storage device 112 or in another storage device of the mobile device.

In some embodiments, to select the image objects of calibration objects of one or more sizes from the detected image objects, the processor 111 selects the image objects of the calibration objects of one or more sizes from the detected image objects according to sizes of historical matching calibration objects, where the sizes of the historical matching calibration objects are the sizes of calibration objects in a historical image obtained by photographing the calibration device that are selected and capable of determining the position-attitude information of the mobile device.

In some embodiments, to select the image objects of calibration objects of one or more sizes from the detected image objects, the processor 111 selects the image objects of the calibration objects of one or more sizes from the detected image objects according to the number of the image object of calibration object of each size.

In some embodiments, to select the image objects of calibration objects of one or more sizes from the detected image objects, the processor 111 selects the image objects of the calibration objects of one or more sizes from the detected image objects according to historical distance information, where the historical distance information is distance information of the mobile device relative to the calibration device determined according to a historical image obtained by photographing the calibration device.

In some embodiments, to select the image objects of calibration objects of one or more sizes from the detected image objects, the processor 111 determines a selection order of the detected image objects, and selects the image objects of the calibration objects of one or more sizes from the detected image objects according to the selection order.

In some embodiments, to determine the selection order of the detected image objects, the processor 111 may determine the selection order according to one or more of the sizes of the historical matching calibration objects, the number of the image object of calibration object of each size, and the historical distance information, where the sizes of the historical matching calibration objects are the sizes of calibration objects selected in a historical image obtained by photographing the calibration device and capable of determining the position-attitude information of the mobile device, and the historical distance information is distance information of the mobile device relative to the calibration device determined according to a historical image obtained by photographing the calibration device.

In some embodiments, the mobile device further includes a communication circuit for receiving the control instruction sent by the control device. The communication circuit may be a circuit, e.g., WIFI, Bluetooth, etc., that can implement wireless communication, or a wired communication circuit.

In some embodiments, the mobile device can be the mobile device 210 shown in FIG. 2. As shown in FIG. 2, the mobile device 210 further includes a carrier device 212 that is configured to carry the photographing device 211. In some embodiments, the mobile device 210 is an unmanned aerial vehicle (UAV), and the photographing device 211 may be a main camera of the UAV. The carrier device 212 can be a two-axis or three-axis gimbal. In some embodiments, the mobile device 210 is also provided with a functional circuit, e.g., a visual sensor, an inertial measurement device, etc., according to an actual need.

The device may be configured to execute the technical solutions of the method embodiments executed by the mobile device consistent with the disclosure, such as one of the above-described example methods. The implementation principle and technical effect are similar, and will not be repeated here.

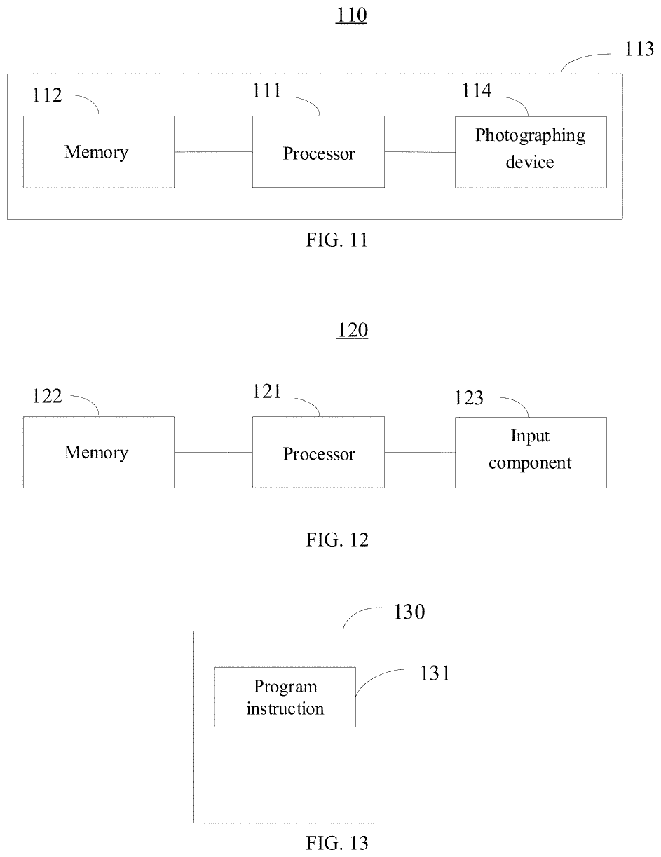

FIG. 12 is a schematic structural diagram of a control device 120 according to one embodiment of the present disclosure. The control device 120 may be any control device, e.g., a remote control device, a somatosensory control device, etc. As shown in FIG. 12, the control device 120 includes an input component 123, a processor 121, and a memory 122, where the memory 122 and the input component 123 are coupled to the processor 121.

The input component 123 is configured to input the operation information of the user and can be a joystick, a keyboard, or a display screen, etc.

The memory 112 and the processor 111 described above can be referred to for the hardware structures of the memory 122 and the processor 121.

The memory 122 is configured to store a program instruction.

The processor 121 calls the program instruction, and the execution of the program instruction can implement the following processes: generating and sending a control instruction to be executed to the mobile device according to operation information input by the user on the input component 123; receiving a feedback instruction sent by the mobile device, where the feedback instruction is sent by the mobile device when predicting a movement status according to position-attitude information and the control instruction to be executed and determining the predicted movement status does not meet a set movement condition; and constraining the operation of the control device in response to the feedback instruction, so that the control instruction generated by the control device makes the mobile device meet the set movement condition.

In some embodiments, to constrain the operation of the control device in response to the feedback instruction, the processor 121 controls the input component 123 in response to the feedback instruction, so that the operation input by the user through the input component 123 can realize that the mobile device meets the set movement condition.

Further, in some embodiments, the input component 123 is moved by the user to implement the input of the operation information. To control the input component in response to the feedback instruction, the processor 121 is configured to generate a resistance opposite to the current operation direction of the user on the input component 123 when it is detected that the user performs an operation on the input component that causes the mobile device not to meet the set movement condition, or determine an allowable operation range of the input component 123 according to the feedback instruction, to restrict the user to operate within the allowable operation range.

The device may be configured to execute the technical solutions of the method embodiments executed by the control device consistent with the disclosure, such as one of the above-described example methods. The implementation principle and technical effect are similar, and will not be repeated here.

FIG. 13 is a schematic structural diagram of a storage device 130 according to one embodiment of the present disclosure. As shown in FIG. 13, the storage device 130 stores the program instruction 131, and the running of the program instruction 131 on the processor executes the technical solutions of a method consistent with the disclosure, such as one of the above-described example methods.

The storage device 130 may be a medium that can store computer instructions, e.g., a USB disk, a mobile hard disk, a read-only memory (ROM), a random access memory (RAM), a magnetic disk, or an optical disk, etc., or may be a server that stores the computer instructions. The server may send the stored program instructions to another device to execute, or execute the stored program instructions by itself.

In some embodiments, the method obtains the image objects of the calibration objects by detecting the image obtained by photographing the image calibration device, and matches the detected image objects with the calibration objects in the image calibration device. An image with a water ripple and an image without a water ripple are different in the positional relationship between the image objects in the image and the corresponding matching calibration objects, and it can be determined whether an image has a water ripple according to the position of the image objects in the image and the position of the corresponding matching calibration object in the image calibration device. An intelligent detection of water ripple in the image is realized without manual detection, which can improve the detection efficiency. In addition, compared with manual detection, the intelligent detection method can reduce an occurrence of a false detection or a missed detection, and thereby improving the detection accuracy and reducing time-consuming.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The integrated unit may be implemented in the form of hardware, or in the form of hardware plus software functional units.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, or a processor, to perform part or all of a method consistent with the disclosure, such as one of the example methods described above. The storage medium can be any medium that can store program instructions, for example, a USB disk, a mobile hard disk, a read-only memory (ROM), a random access memory (RAM), a magnetic disk, or an optical disk.

The present disclosure has been described with the above embodiments, but the technical scope of the present disclosure is not limited to the scope described in the above embodiments. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the claims.

What is claimed is:

1. A method for controlling a mobile device comprising:
obtaining a measurement image of a calibration device including a plurality of calibration objects;
obtaining position-attitude information of the mobile device according to the measurement image;
predicting a movement status of the mobile device according to the position-attitude information and a control instruction to be executed; and
constraining, in response to the predicted movement status not meeting a movement condition, movement of the mobile device so that the movement status after constraining meets the movement condition.

2. The method of claim 1, wherein constraining the movement of the mobile device includes:
generating a new control instruction that enables the mobile device to meet the set movement condition; and
controlling the mobile device to move according to the new control instruction.

3. The method of claim 2, wherein generating the new control instruction includes:
generating, according to a control setting law, the new control instruction based on the predicted movement status and the movement condition.

4. The method of claim 1, wherein constraining the movement of the mobile device includes:
sending a feedback instruction to a control device that sends the control instruction, to constrain an operation of the control device, a control instruction generated with the constrained operation enabling the mobile device to perform a movement that meets the movement condition.

5. The method of claim 4, wherein:
the control instruction is generated by the control device according to a user operation on an input component of the control device; and
the operation of the control device is constrained by:
generating a resistance opposite to a current operation direction on the input component in response to detecting that the user operation on the input component causes the mobile device not to meet the movement condition; or
determining an allowable operation range of the input component according to the feedback instruction to restrict the user operation to be within the allowable operation range.

6. The method of claim 1, wherein:
obtaining the measurement image of the calibration device and obtaining the position-attitude information of the mobile device according to the measurement image is repeatedly executed at a plurality of moments, to obtain the position-attitude information of the mobile device at the plurality of moments; and
predicting the movement status of the mobile device includes predicting the movement status of the mobile device according to the position-attitude information at the plurality of moments and the control instructions.

7. The method of claim 1, wherein predicting the movement status of the mobile device includes:
predicting a movement track of the mobile device according to the position-attitude information and the control instruction; and
obtaining the movement status of the mobile device on the predicted movement track.

8. The method of claim 1, wherein the control instruction is sent by a control device or generated by the mobile device.

9. The method of claim 1, wherein the movement condition includes that the mobile device keeps moving within a set range.

10. The method of claim 9, wherein the movement status includes a speed of the mobile device and a relative position between the mobile device and an edge position of the set range.

11. The method of claim 9, further comprising, before obtaining the measurement image:
receiving information of the set range sent by a user device, the information of the set range being obtained by the user device according to a user selection on a global map displayed by the user device, and the global map being built and generated by the user device using position information of the calibration device or a global positioning system (GPS).

12. The method of claim 1, further comprising, before predicting the movement status of the mobile device:
obtaining sensor position-attitude information provided by a sensor of the mobile device; and
calibrating the position-attitude information of the mobile device according to the sensor position-attitude information.

13. The method of claim 1, further comprising:
controlling, in response to the predicted movement status meeting the movement condition, the mobile device to move according to the control instruction.

14. The method of claim 1, wherein:
each of the plurality of calibration objects has a size selected from at least two different sizes; and
obtaining the position-attitude information of the mobile device according to the measurement image includes:
detecting at least two image objects from the measurement image, each of the at least two image objects corresponding to at least one calibration object of one of the at least two different sizes;
selecting one or more image objects from the at least two detected image objects; and
determining the position-attitude information of the mobile device according to the one or more selected image objects.

15. The method of claim 14, wherein selecting the one or more image objects from the at least two detected image objects includes:
selecting the one or more image objects according to a size of a historical matching calibration object, the historical matching calibration object being a calibration object in a historical image obtained by photographing the calibration device that is selected and capable of determining the position-attitude information of the mobile device.

16. The method of claim 14, wherein obtaining the position-attitude information of the mobile device according to the measurement image further includes:
for each selected image object of the one or more selected image objects, determining a corresponding calibration object in the calibration device, including:
determining a position characteristic parameter of the selected image object; and
determining the corresponding calibration object according to the position characteristic parameter of the selected image object and a preset position characteristic parameter of the corresponding calibration object in the calibration device.

17. The method of claim 14, wherein selecting the one or more image objects from the at least two detected image objects includes:
selecting the one or more image objects according to numbers of image objects corresponding to calibration objects of various ones of the at least two different sizes.

18. The method of claim 14, wherein selecting the one or more image objects from the at least two detected image objects includes:
selecting the one or more image objects according to historical distance information of the mobile device relative to the calibration device determined according to a historical image obtained by photographing the calibration device.

19. The method of claim 14, wherein selecting the one or more image objects from the at least two detected image objects includes:
determining a selection order of the at least two detected image objects; and
selecting the one or more image objects according to the selection order.

20. A mobile device comprising:
a body;
a photographing device provided at the body and configured to photograph a calibration device including a plurality of calibration objects to obtain a measurement image;
a memory provided at the body and storing program instructions; and
a processor provided at the body and configured to execute the program instructions to:
obtain the measurement image;
obtain position-attitude information of the mobile device according to the measurement image;
predict a movement status of the mobile device according to the position-attitude information and a control instruction to be executed; and
constrain, in response to the predicted movement status not meeting a movement condition, movement of the mobile device so that the movement status after constraining meets the movement condition.
